(19) United States
(12) Patent Application Publication
(10) Pub. No.: US 2004/0179300 A1
(43) Pub. Date: Sep. 16, 2004

(54) Disk cartridge

(75) Inventor: Junichi Nakamikawa, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/792,220

(22) Filed: Mar. 4, 2004

(30) Foreign Application Priority Data
Mar. 10, 2003 (JP) 063104/2003

(51) Int. Cl. G11B 23/03

(52) U.S. Cl. 360/133

(57) ABSTRACT

A disk cartridge having an improved dust removing capability for removing dirt or dust on a surface of an information recording medium is provided.

The disk cartridge has a recess defining member provided in an outer region, which is located radially outward from a region above the center core in a surface of an upper shutter member on the side facing an information recording medium, so as to define a recess in the region above the center core. An upper liner for wiping off dirt or dust deposited on the information recording medium is placed on the recess defining member.

### BACKGROUND OF THE INVENTION

1. Field of the Invention

The present invention relates to disk cartridges which rotatably accommodate a disk-shaped information recording medium.

2. Description of the Related Art

Conventionally, mobile equipment such as digital cameras, use as recording media very small magnetic disk cartridges called “clik!™” (see, for example, U.S. Pat. Nos. 6,133,544 and 5,995,346). FIG. 5 shows an example of a conventional very small magnetic disk cartridge called “clik!™”. A disk cartridge 1 illustrated in FIG. 5, for example, comprises an information recording medium, about 1.8 inch (46.5 mm) in diameter, which is a magnetic disk with a 40 MB storage capacity; and a housing (width 50 mm, depth 55 mm, thickness 1.95 mm) which has upper and lower shells 3, 4 formed of a flat thin metal sheet and rotatably accommodates therein the information recording medium 5.

The upper and lower shells 3, 4 have an opening (not shown) to allow a recording/reproducing head to access the information recording medium 5. The lower shell 4 has a center hole 4a for exposing towards the exterior a center core 10 which is centrally disposed in the information-recording media 5. Further, a rotary shutter 7 for opening and closing the opening is provided within the upper and lower shells 3, 4.

The rotary shutter 7 is constituted by an upper shutter member 7U which is rotatably supported by the upper shell 3, and a lower shutter member 7D which is rotatably supported by the lower shell 4. Further, an upper liner 8U for wiping off dirt and dust deposited on the surface of the information recording medium 5 is affixed to the surface of the upper shutter member 7U on the side opposed to and facing the information recording medium 5 (also referred to hereinafter as “opposite surface”). Similarly, a lower liner 8D is affixed to the surface of the lower shutter member 7D on the side facing the information recording medium 5.

A lower gap DD between the lower shutter member 7D and the information recording medium 5 is dimensioned such that a pressure sufficient for removing dirt and dust is applied to the information recording medium 5 by the lower liner 8D when the disk drive is loaded, for example, 0.285 mm to 0.323 mm. On the other hand, an upper gap UD between the upper shutter member 7U and the information recording medium 5 is dimensioned to be wider than the lower gap DD when the disk drive is loaded, for example, 0.45 mm to 0.451 mm. This is because a higher priority is given to prevention of damage to the information recording medium 5, which could be caused by the pressure generated when the center core 10 is moved upwardly towards the upper shutter member 7U by a rotary drive member of the disk drive when the disk cartridge 1 is loaded into the disk drive, than the dust removing capability of the upper liner 8U, and thus a clearance space for the center core 10 is provided inside the upper shell 3.

However, when the upper gap UD between the upper shutter member 7U and the information recording medium 5 is selected giving a higher priority to damage prevention as mentioned above, the upper liner 8U can not exert sufficient pressure to remove dirt and dust from the information recording medium 5, and thus there arises a problem that dirt or the like deposited on the upper side of the information recording medium. 5 is difficult to be removed.

### SUMMARY OF THE INVENTION

In view of the foregoing, it is an object of the invention to provide a disk cartridge having an improved dust removing capability with respect to an information recording medium.

One aspect of the invention provides a disk cartridge comprising: a disk-shaped information recording medium having a center core centrally attached thereto; and a flat housing which has upper and lower shells and rotatably accommodates therein the disk-shaped information recording medium, the housing including an opening to allow access to the surface of the disk and a rotary shutter for opening and closing the opening, the rotary shutter being constituted by an upper shutter member which is rotatably supported by the upper shell, and a lower shutter member which is rotatably supported by the lower shell, wherein the upper shutter member has a recess defining member which is provided on an outer region radially outward from a region above the center core in the surface thereof on the side opposed to and facing the information recording medium so as to define a recess in the region above the center core; and an upper liner which is placed on the recess defining member and serves to wipe off dirt and dust deposited on the information recording medium.

It will be noted that a “region above the center core” may be any region in the upper shutter member which includes a portion facing the center core, and may be, for example, a region including an outer edge of a portion facing the center core.

The “recess defining member” may be any member capable of defining a recess in the region above the center core in the opposite surface. For example, the recess defining member may be made up of adhesive for affixing the upper liner to the upper shutter member, or may be formed integrally with the upper liner using the same material as the upper liner.

Further, a lower liner is provided on the opposite surface of the lower shell opposed to and facing the information recording medium. The recess defining member provided thereon is preferably of a thickness selected such that the both surfaces of the information recording medium are subjected to substantially the same pressure respectively from the upper and lower liners when the disk cartridge is loaded into a disk drive.

Another aspect of the invention provides a disk cartridge comprising: a disk-shaped information recording medium having a center core centrally attached thereto; and a flat housing which has upper and lower shells and rotatably accommodates therein the disk-shaped information recording medium, the housing including an opening to allow a recording/reproducing head of a disk drive to access a surface of the information recording disk, and a rotary shutter for opening and closing the opening, and the rotary shutter being constituted by an upper shutter member which is rotatably supported by the upper shell and a lower shutter member which is rotatably supported by the lower shell, wherein the surfaces of the upper and lower shutter members facing the information recording medium are provided with a liner for wiping off dirt and dust deposited on the surfaces of the information recording medium; wherein the upper shutter member has a step portion between a region above the center core, which is included in the opposite surface thereof facing the information recording medium, and an outer region, which is located radially outward from the region above the center core, in order to define a recess in the region above the center core, and wherein the step portion serves to produce a height difference such that the distance from the information recording medium to the lower shutter member and the distance from the information recording medium to the opposite surface in the outer region become substantially the same when the disk cartridge is loaded in the disk drive.

In accordance with the disk cartridge according to the first aspect of the present invention, a recess defining member is provided in the outer region, which is located radially outward from the region above the center core, of the surface of an upper shutter member on the side facing the information recording medium, and an upper liner is placed on the recess defining member. Thus the center core is received within the recess when the disk drive lifts the center core towards the upper shutter member, and the information recording medium is positioned between the center core and the upper shutter member. This prevents the surface of the information recording medium from being damaged and also allows the upper liner placed on the recess defining member to exert to the information recording medium a sufficient pressure for wiping off dirt and dust deposited on the medium. As a result, the dust removing capability of the disk cartridge can be improved.

The recess defining member may be made up of adhesive for affixing the upper liner to the upper shutter member. With this configuration, the recess defining member can be provided by applying a thicker coat of adhesive to the upper shutter member and affixing the upper liner on the coat of adhesive, so that the recess forming operation can be performed easily.

Further, the recess defining member may be formed integrally with the upper liner using the same material as the upper liner. With this configuration, the recess can be formed in the region above the center core merely by placing the upper liner on the upper shutter member, so that the recess forming operation can be performed easily.

Furthermore, the recess defining member may have a thickness selected such that the distance from the surface of the information recording medium to the upper liner and the distance from the surface of the information recording medium to the lower liner are substantially the same. With this configuration, the pressure applied to the information recording medium from the upper liner and the pressure applied to the information recording medium from the lower liner become substantially the same, which enables prevention of vertical runout of the information recording medium during rotation.

Further, in accordance with the disk cartridge according to the second aspect of the present invention, the upper shutter member includes a step portion between a region above the center core and an outer region located radially outward therefrom, and the step portion serves to produce a height difference such that the distance from the information recording medium to the lower shutter member and the distance from the information recording medium to the opposite surface in the outer region of the upper shutter member become substantially same when the disk cartridge is loaded in the disk drive. Thus the center core is received within the recess when the disk drive moves the center core upward towards the upper shutter member, and the information recording medium is positioned between the center core and the upper shutter member. This prevents the surface of the information recording medium from being damaged, and also allows the upper liner provided on the recess defining member to exert to the information recording medium a pressure sufficient for wiping off dirt deposited on the medium. As a result, the dust removing capability of the disk cartridge can be improved.

### BRIEF DESCRIPTION OF THE DRAWINGS

FIG. 1A is a plan view, FIG. 1B is a side view, and FIG. 1C is a bottom view of the disk cartridge according to the preferred embodiment of the invention with the rotary shutter closed.

FIG. 2A is a plan view and FIG. 2B is a bottom view of the disk cartridge according to the preferred embodiment of the invention with the rotary shutter open.

FIG. 3 is a schematic view in the disk cartridge shown in FIG. 1 illustrating an embodiment of an assembled configuration of upper and lower shells and rotary shutter.

FIG. 4A and FIG. 4B are schematic views showing disk cartridges in accordance with alternate embodiments of the present invention.

FIG. 5 is a schematic view showing one example of a conventional disk cartridge.

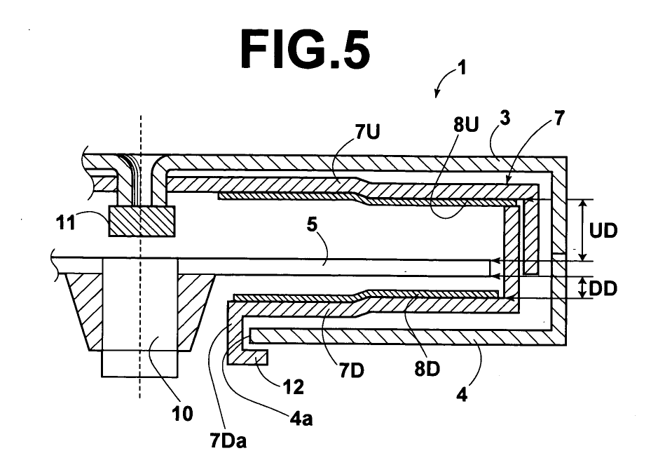

### DESCRIPTION OF THE PREFERRED EMBODIMENTS

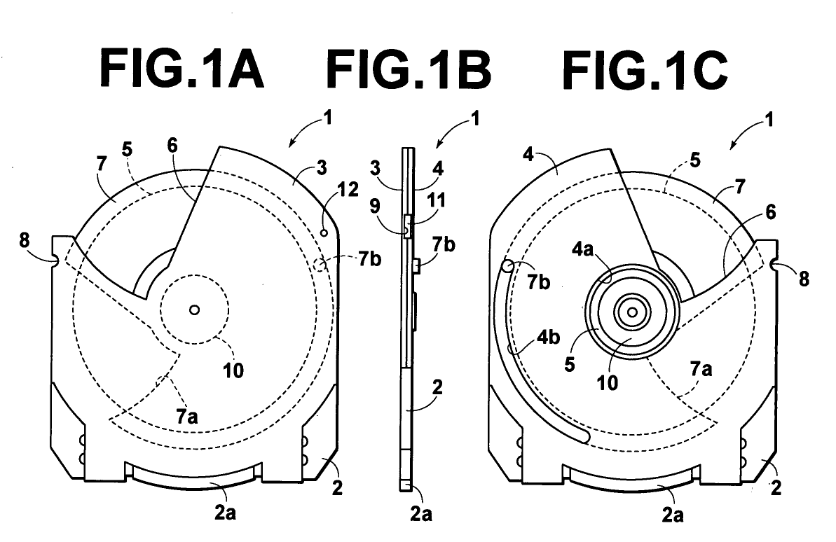

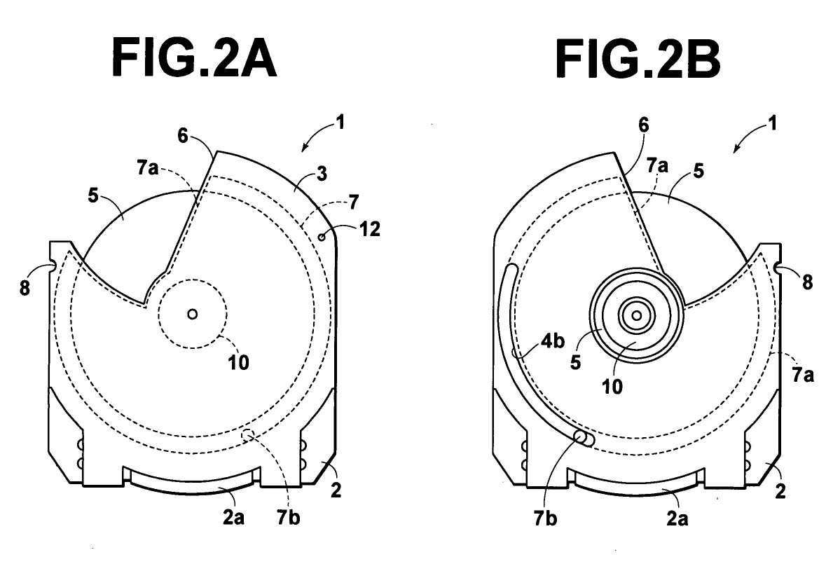

Hereinafter, embodiments of the present invention will be described in detail with reference to the drawings. FIGS. 1A to 1C show a disk cartridge in accordance with a first embodiment of the present invention. FIG. 1A is a plan view, FIG. 1B is a side view, and FIG. 1C is a bottom view, with its rotary shutter 7 closed. FIG. 2A is a plan view and FIG. 2B is a bottom view of the disk cartridge in FIG. 1 shown with the rotary shutter 7 open.

The disk cartridge 1 comprises a flat housing (width 50 mm, depth 55 mm, thickness 1.95 mm) constituted by a resin frame 2 including a push portion 2a for pushing the disk cartridge into a disk drive, for example, by a finger or the like, and upper and lower shells 3, 4 formed of a thin metal sheet; and an information recording medium 5 which is a about 1.8″ (46.5 mm) diameter magnetic disk and accommodated in the flat housing. The lower shell 4 has a center hole 4a for exposing towards the exterior a center core 10 which is centrally located in the information recording medium 5.

Each of the upper and lower shells 3, 4 is provided with a wedge-shaped opening 6 to allow a magnetic head of the disk drive, into which the cartridge 1 is inserted and loaded, to access the surface of the information recording medium 5. A rotary shutter 7 for opening and closing the opening 6 is disposed within each of the upper and lower shells 3, 4.

The rotary shutter 7 is formed in a generally disk-like shape, and provided with an opening 7a which has the substantially same shape as the opening 6 of the housing. The rotary shutter 7 further has a shutter knob 7b which projects towards the lower shell 4, and the lower shell 4 includes an arcuate groove 4b concentric with the rotary shutter 7 into which the shutter knob 7b is inserted. When shutter knob 7b moves along the arcuate groove 4b from a state in which the opening 6 of the rotary shutter 7 is closed as shown in FIGS. 1A, 1B, and 1C, the opening 7a of the rotary shutter 7 is positioned to overlap with the opening 6 of the housing, and consequently the information recording-medium 5 is exposed, as shown in FIGS. 2A and 2B.

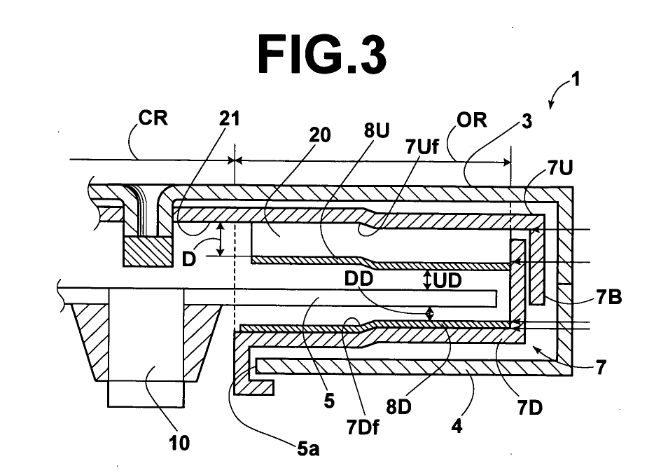

FIG. 3 is a sectional view of the disk cartridge shown in FIGS. 1A, 1B, and 1C. Referring to FIG. 3, the rotary shutter 7 is constituted by upper and lower shutter members 7U, 7D which are engaged with each other. The upper shutter member 7U is rotatably supported by the upper shell 3, while the lower shutter member 7D is rotatably supported by the lower shell 4. Upper and lower liners 8U, 8D are disposed between the information recording medium 5 and the upper and lower shutter members 7U, 7D, respectively.

The lower liner 8D is affixed to a surface 7Df of the lower shutter member 7D on the side facing the information recording medium 5, and a lower gap DD between the lower liner 8D and the information recording medium 5 is dimensioned such that a pressure suitable for wiping off dirt and dust deposited on the information recording medium 5 is exerted to the medium.

Meanwhile, the upper liner 8U is affixed to the upper shutter member 7U via a recess defining member 20. The recess defining member 20 is made up of adhesive for affixing the upper liner 8U to the upper shutter member 7U, and provided on an outer region OR located radially outward from a region CR above the center core 10 to form a recess 21 in the region CR above the center core 10 in a surface 7Uf of the upper shutter member 7U facing the information recording medium 5.

The recess defining member 20 has a thickness D of about 0.13 mm to about 0.17 mm, and is formed such that the length of the upper gap UD between the upper liner 8U and the information recording medium 5 is substantially same as that of the lower gap between the lower liner 8D and the information recording medium 5. Thus, also in the upper liner 8U, the upper gap UD is dimensioned to have a width such that a pressure suitable for wiping off dirt and dust deposited on the information recording medium 5 is ensured, and accordingly the dust removing capability can be improved for both surfaces of the information recording medium 5. Furthermore, since the recess 21 is formed within the region CR above the center core 10, the information recording medium 5 can be prevented from being damaged due to abutment with the upper shutter member 7U when the center core 10 is lifted towards the upper shutter member 7U when the disk cartridge 1 is loaded into the disk drive.

In addition, since the thickness of the recess defining member 20 is selected such that the upper gap UD and the lower gap DD are substantially the same as mentioned above, vertical runout of the information recording medium 5 during rotation are prevented, and accordingly, recording and reproducing can be performed with stable rotation of the information recording medium 5.

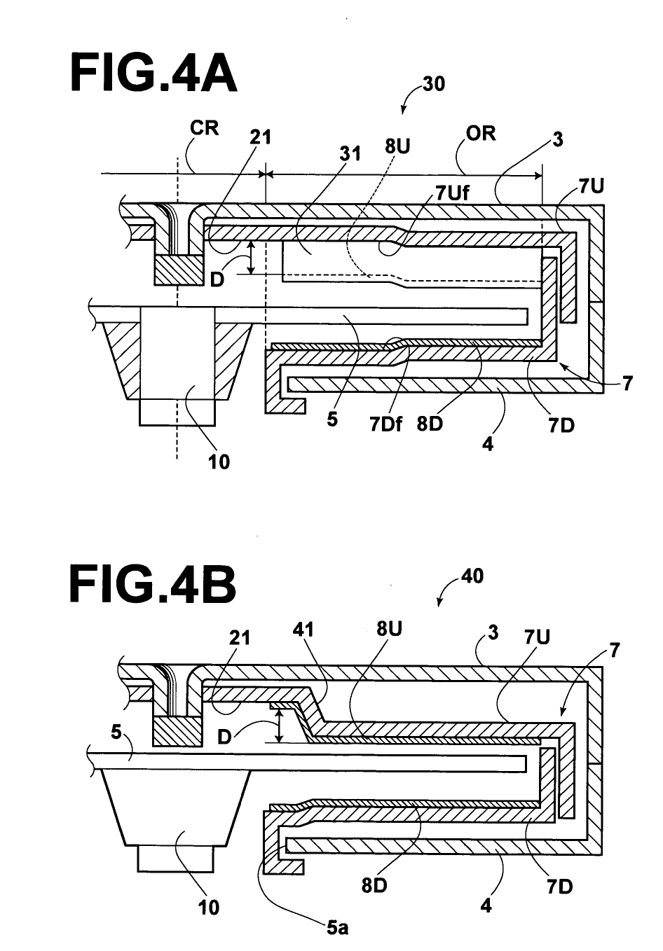

FIGS. 4A and 4B schematically show a disk cartridge according to a second embodiment of the present invention. For disk cartridges 30, 40 shown in FIGS. 4A and 4B, the same elements as those in the disk cartridge 1 shown in FIG. 1 are designated by the same reference numerals and explanation thereof will be omitted. The disk cartridge 30 shown in FIG. 4A differs from the disk cartridge 1 shown in FIG. 1 in the configuration of the recess defining member.

In the disk cartridge 30 shown in FIG. 4A, a recess defining member 31 is formed integrally with an upper liner 8U using the same material as the upper liner 8U. Specifically, the recess defining member 31 and the upper liner 8U are made by affixing a liner which is 0.13 mm to 0.17 mm thicker than the lower liner 8D affixed to an outer region OR. This obviates the step of affixing the upper liner 8U to the recess defining member 31, thereby simplifying operations for forming the recess 21.

In a conventional disk cartridge 1, an upper liner 8U is not present on a part around a retaining member 11 in a region CR above the center core, as a result of which a height difference is produced between the upper shell 3 and the upper liner 8U. However, this height difference is disposed within the region CR above the center core 10, and does not serve to define a clearance space for the center core 10. Therefore, it is necessary for the conventional disk cartridge 1 to provide a wider upper gap UD. In contrast, in the disk cartridge 1 shown in FIG. 4A, a height difference is produced radially outward from the region CR above the center core 10, and serves to define the recess 21, which provides a clearance space for the center core 10, in the region CR above the center core. Accordingly, even when the center core 10 is lifted towards the upper shell 3 when the disk cartridge 1 is loaded into the disk drive, the information recording medium 5 can be prevented from being damaged.

On the other hand, in the disk cartridge 40 shown in FIG. 4B, a tapered step portion 41 is provided between the area CR above the center core 10 and the outer region OR by bending the upper shutter member 7U. The tapered step portion 41 serves to produce a height difference, for example, about 0.13 mm to about 0.17 mm, such that the distance from the information recording medium 5 to its opposing surface of the lower shutter member and the distance from the information recording medium 5 to its opposing surface in the outer region CR are substantially the same. By providing the step portion 41 in the upper shutter member 7U, in this way, a recess can be formed in the region CR above the center core 10 without the necessity of additionally providing a recess defining member. Thus, the information recording medium 5 is prevented from being damaged even when the center core 10 is lifted towards the upper shell 3 when the disk cartridge 40 is loaded into the disk drive, while the dust removing capability to the information recording medium 5 is improved. Preferably, the step portion 41 is disposed inside the outer region OR and outside the data area of the information recording medium 5.

In the aforementioned respective embodiments, as shown in FIG. 3, the recess defining member 20 is provided in the outer region OR located radially outward from the region CR above the center core 10 in the opposing surface of the upper shutter member 7U and an upper liner 8U is provided on the recess defining member 20. Such a configuration enables prevention of the information recording medium 5 from damage by the provision of the recess 21 defined by the recess defining member 20 when the center core 10 is lifted towards the upper shutter member 7U by the disk drive. At the same time, pressure from the upper liner 8U placed on the recess defining member 20 for wiping off dirt and dust deposited on the information recording medium 5 is ensured, and accordingly the dust removing capability of the disk cartridge 1 can be improved.

The recess defining member 20 may be made up of an adhesive for attaching the upper liner to the upper shutter member 7U. With this configuration, the recess defining member 31 can be provided by applying a thicker coat of adhesive to the upper shutter member 7U and attaching the upper liner 8U on the coat of adhesive, so that the recess 21 can be formed easily on the region CR on the center core 10.

Further, as shown in FIG. 4A, when the recess defining member 31 is formed integrally with the upper liner 8U using the same material as the upper liner 8U, the recess is formed in the region CR above the center core 10 merely by placing the upper liner 8U on the upper member 7U. Thus the recess 21 can be easily provided in the region CR above the center core 10. Since the upper liner and recess defining member 31 which are formed in one piece are made of soft material, the information recording medium 5 can be prevented from being damaged even when an edge portion of the recess defining member 31 formed between the region CR above the center core 10 and the outer region OR thereof or an edge portion of the upper liner 8U abuts against the information recording medium 5.

In addition, by providing the step portion 41 in the upper shutter member 7U as shown in FIG. 4B, a recess can be formed in the region CR above the center core 10 without the necessity of additionally providing a recess defining member. Accordingly, the information recording medium 5 is prevented from being damaged even when the center core 10 is lifted towards the upper shell 3 when the disk cartridge 40 is loaded into the disk drive, while the dust removing capability to the information recording medium 5 is improved.

It will be understood that the invention is not restricted to the aforementioned and illustrated embodiments thereof. For example, while FIG. 3 depicts the recess defining member 20 made up of adhesive, it is also within the scope of the invention that the recess defining member 20 is made up of a double faced adhesive tape or a plastic member affixed to the upper opposing surface.

What is claimed is:

1. A disk cartridge comprising:
a disk-shaped information recording medium having a center core centrally attached thereto;
a flat housing which has upper and lower shells and rotatably accommodates therein the disk-shaped information recording medium;
the housing including an opening to allow a recording/reproducing head of a disk drive to access a surface of the information recording disk, and a rotary shutter for opening and closing the opening; and
the rotary shutter being constituted by an upper shutter member which is rotatably supported by the upper shell and a lower shutter member which is rotatably supported by the lower shell,
wherein the upper shutter member comprises:
a recess defining member which is provided on an outer region radially outward from a region above the center core in the surface thereof on the side opposed to and facing the information recording medium so as to define a recess in the region above the center core; and
an upper liner which is placed on the recess defining member and serves to wipe off dirt and dust deposited on the information recording medium.

2. A disk cartridge according to claim 1, wherein the recess defining member is made up of adhesive for affixing the upper liner to the upper shutter member.

3. A disk cartridge according to claim 1, wherein the recess defining member is formed integrally with the upper liner using the same material as the upper liner.

4. A disk cartridge according to claim 1, wherein a lower liner is provided on the surface of the lower shell on the side facing the information recording medium, and the recess defining member has a thickness selected such that the both surfaces of the information recording medium are subjected to substantially the same pressure respectively from the upper and lower liners when the disk drive is loaded.

5. A disk cartridge comprising:
a disk-shaped information recording medium having a center core centrally attached thereto;
a flat housing which has upper and lower shells and rotatably accommodates therein the disk-shaped information recording medium;
the housing including an opening to allow a recording/reproducing head of a disk drive to access a surface of the information recording disk, and a rotary shutter for opening and closing the opening; and
the rotary shutter being constituted by an upper shutter member which is rotatably supported by the upper shell and a lower shutter member which is rotatably supported by the lower shell,
wherein the surfaces of the upper and lower shutter members facing the information recording medium are provided with a liner for wiping off dirt and dust deposited on the surfaces of the information recording medium;
wherein the upper shutter member has a step portion between a region above the center core, which is included in a surface thereof facing the information recording medium, and an outer region which is located radially outward from the region above the center core, in order to define a recess in the region above the center core; and
wherein the step portion serves to produce a height difference such that the distance from the information recording medium to the lower shutter member and the distance from the information recording medium to the opposite surface in the outer region become substantially the same when the disk cartridge is loaded in the disk drive.
